(19) United States
(12) Patent Application Publication
(10) Pub. No.: US 2002/0188886 A1
(43) Pub. Date: Dec. 12, 2002

(54) Method and apparatus for backing up application code upon power failure during a code update

(76) Inventors: Xiaodong Liu, Carmel, IN (US); Aaron Hal Dinwiddie, Cicero, IN (US)

Correspondence Address: Joseph S Tripoli, Thomson Multimedia Licensing Inc, PO Box 5312, Princeton, NJ, 08543-5312, US

(21) Appl. No.: 10/169,441

(22) PCT Filed: Jan. 4, 2001
(86) PCT No.: PCT/US01/00329

(30) Foreign Application Priority Data
Jan. 7, 2000 (US) 60174997

(51) Int. Cl. G06F 11/08; G06F 11/36

(52) U.S. Cl. 714/6; 714/38

(57) ABSTRACT

A system, method and apparatus for updating computer code in a computer controlled device overcome glitches in updating of the computer code. The present invention allows upgrading of the computer code via any upgrade channel or mechanism. In one form, back-up code corresponding to application code is stored in memory. Upon a power failure or other glitch in which the application code becomes corrupt, back-up code is utilized by the boot code to provide a version of the application code for operation of the computer controlled device. In one form, the upgrade is accomplished via a smart card.

### FIELD OF THE INVENTION

The present invention relates to updating computer code in computer controlled devices and, more particularly, to a method and apparatus for updating computer code in a computer or micro-processor controlled device utilizing an integrated circuit card (smart card) interface and/or in the event of a power failure during updating.

### BACKGROUND OF THE INVENTION

Many consumer electronics devices such as pay television (TV) systems, set top cable television boxes, terrestrial television receivers, satellite television receivers and the like, require periodic software updates to provide signal processing, interactive features, and security improvements to the consumer. Software upgrades for such devices are generally performed by replacing the read only memory chips within the device or connecting a computer to a data port on the device to download the software upgrade into the memory of the device.

In some instances, such upgrades require a technician to visit the consumer's location and perform the upgrade of the software. Alternatively, the consumer must return the device to the manufacturer, then be provided a replacement device that contains the upgraded software. Such a software upgrade process is time consuming, costly, and annoying to the consumer.

When the entire memory chip is replaced, there typically are no problems associated the operation of the software, since the entire software has been replaced. However, if there is a glitch during a software upgrade, there may be a problem ranging from minor to catastrophic (i.e. device failure). Irrespective of its drawbacks, however, the upgrade method is preferred.

One way to structure the memory of the device to allow easier and less potentially problem producing upgrading of the system software is to partition the system software, code, or memory into two parts. One part is typically non-changeable and it usually boots up the device and performs the task of upgrading the remaining portions of the software. The other part is changeable, and it performs all the functions the device is supposed to deliver to the consumer. This part is often updated to have the latest “feature sets”. The non-changeable part may be termed the boot code or boot code part, while the changeable part may be termed the application code or application code part (i.e., it contains the product features of the application code).

In view of the above, if a power failure condition occurs during downloading of the new boot code, the device may fail. This type of event could be extremely bad when a new code is broadcast over a service satellite to millions of devices and the working code in the devices have been erased and the new code is yet to be placed in. Basically, the power fail condition has paralyzed these devices. The recovery operation from this event could be very costly to the device manufacturer.

Under a current satellite broadcast code upgrade scenario (for example DBS or Direct Broadcast Systems), in the event of an upload glitch such as a power failure or fail condition, the manufacturer has to either prepare redundant application code storage in the product, or set up a service network to fix the memory corrupted products. These measures are very expensive and will interrupt a consumer's daily viewing activities.

There is thus a need for an improved technique for protecting the application code's working capability under the mentioned conditions.

### SUMMARY OF THE INVENTION

In one form, the present invention is a method and apparatus for updating application code for a computer controlled device. The upgrading is particularly accomplished via a data connection with the computer controlled device, such as by satellite, cable TV system, telephone system, and/or the like. The present invention utilizes memory management and a compressed version of the boot code to provide a back-up to the computer controlled device. The invention is particularly applicable in the event of a power failure or fail condition during the upgrade process, or any time the code becomes corrupted.

According to this aspect, the present invention provides software and/or code along with related memory planing to achieve an overall code protection implementation in a computer controlled device. This may be accomplished within a minimum memory budget of the computer controlled device.

A software storage device, such as a ROM (Read Only Memory), is partitioned into three areas: (1) a non-changeable boot code area; (2) a changeable application code area; and (3) a backing or back-up code area. The boot code area contains the boot code. The application code area contains the application code. The backing or back-up code area contains the back-up code, preferably in a compressed state.

The boot code is operable to boot up the application software operation and will replace the existing application code with a newer version of application code when it is instructed to do so. However, the boot code may not have the features of authenticating and collecting the new application code from the upgrade channel or mechanism (e.g. a direct broadcast system (DBS) satellite).

The application code contains all the product features. In a DBS environment, for example, the application code will contain a video/audio display, program parsing, pay per view, etc. In accordance with an aspect of the present invention, the new application code download authentication and download code packet processing is in the current application code segment. This is advantageous in that these complex features (i.e. download authentication and download data packet collection) can be upgraded along with the application code.

The backing code is operable to ensure that the computer controlled device can receive and authenticate a new application code download in case the current existing application code becomes corrupted. The backing code can expand its feature(s) to the feature(s) of the application code given the backing code being properly packed or compressed. The feature set of the backing code could be changed and be varying from the mentioned fundamental function to the full functions of the application code under design. The backing code can be upgraded at the customer's site with a non-power-fail-destructive method. Such a method is described in a disclosure numbered RCA 89210, owned by the current assignee, Thomson Consumer Electronics, of Indianapolis, Ind., USA.

With a reasonable size of memory, and preferably non-volatile memory, preserved for the backing code, implementation of properly selected feature sets, and good image packing or compression to compress the backing code, the under-designed upgradeable computer controlled device (e.g. a DBS receiver) can achieve relative low hardware cost, highly reliable upgrade operation performance, and non-interruptible customer service, particularly in the case of corruption of the current application during a download or upgrade process.

In another one form, the present invention is a method and apparatus for providing computer code through a smart card interface. The invention utilizes a memory card, i.e., a smart card containing a solid state memory device, that stores software that is used to update (or otherwise supplement) the software within a computer controlled device.

More particularly, in accordance with an aspect of the present invention, the smart card interface within the computer controlled device determines whether the card that is inserted into the smart card interface is either a memory card or a conventional smart card.

A memory card has a connector arrangement that complies with ISO standard 7816-2 and high speed data ports of an NRSS-type card such that the software update can be performed through the smart card interface. Once the smart card interface has detected that a memory card has been inserted, the interface requests data from the card. Specifically, the interface provides an NRSS-type clock signal to the memory card causing the NRSS data port to supply the computer code update from the memory card at the rate of about 42 Mbits/second.

The smart card interface reads the data stream header within the data being supplied by the memory card such that the interface makes a decision to accept the computer code data or reject that data. The header information also supplies the interface with operation termination conditions, e.g., end of file information. The interface provides the computer code to the memory of the computer controlled device to update the computer code therein.

### BRIEF DESCRIPTION OF THE DRAWINGS

Reference to the following description of the present invention should be taken in conjunction with the accompanying drawings, wherein:

FIG. 1 is a diagrammatic representation of a system having a computer controlled device capable of receiving software updates in accordance with the principles of the present invention;

FIG. 2 depicts a non-volatile memory arrangement for a computer controlled device in accordance with the principles of the present invention;

FIG. 3 is a diagrammatic depiction of the non-volatile memory arrangement and computer controlled device during backing code installation;

FIG. 4 is a flow chart depicting operation of an aspect of the present invention utilizing the non-volatile memory arrangement of FIG. 2;

FIG. 5 depicts a block diagram of a software updating system for a computer controlled device having a smart card interface in accordance with an aspect of the principles of the present invention; and

FIG. 6 depicts a flow diagram showing operation for the updating system of FIG. 5 in accordance with the principles of the present invention.

Corresponding reference characters indicate corresponding parts throughout the several views.

### DETAILED DESCRIPTION OF THE INVENTION

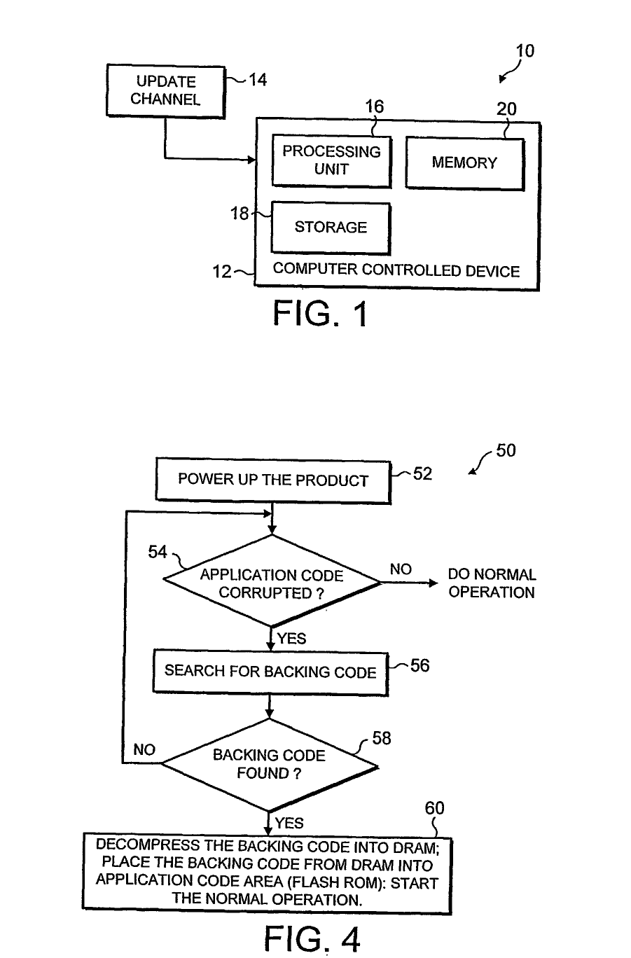

With reference to FIG. 1, there is depicted a block diagram, generally designated 10, of a system having operational software and operable to upgrade at least a portion of the operational software. The system 10 includes a computer controlled device 12 that is connectable to an update channel or mechanism 14 (collectively channel). It should be appreciated that the computer controlled device 12 may be any type of computer controlled device such as are in broad use as or within consumer electronics components such as, without being exhaustive, direct broadcast satellite television systems, set top boxes for cable and video-on-demand systems, high definition television systems, and the like. As well, the upgrade channel 14 represents a plurality of mechanisms, manners, ways and the like of receiving an upgrade in accordance with the principles presented herein. The upgrade channel, without being exhaustive, includes transmitted and received upgrades and direct upgrade from an auxiliary device or storage device. Transmitted is and received upgrade channels includes satellite (as through a DBS), a cable television system through a set top box, terrestrial broadcast system through a television signal receiver, and the like. Auxiliary devices includes memory sticks, memory cards, smart cards, and the like. Hereafter, the present invention will be described in connection with the access channel being a satellite or DBS system and the computer controlled device being a DBS receiver. It should be appreciated that this selection of the access channel and computer controlled device is arbitrary. The principles of the present invention explained herein in connection with a DBS receiver and DBS system apply to all computer controlled devices upgraded via any access channel.

The computer controlled device 12 typically includes a processing unit, microcontroller, or the like 16, memory 20 such as ROM or the like, and data storage 18. The computer controlled device 12 also includes other components as are necessary for operation of the particular device. The memory 20, in one form, includes non-volatile memory and volatile memory.

The computer controlled device 12 operates, at least in part, under the control of instructions, code, and/or software (collectively software). The software is contained in the memory 20. The computer controlled device 12 is operable to allow the-upgrade or update of at least part of its software via the update channel 14.

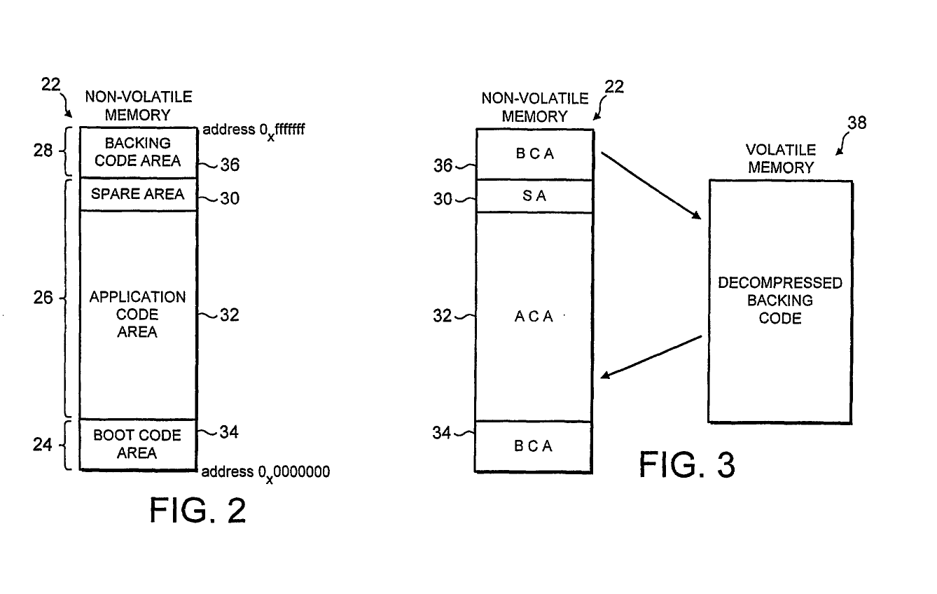

Referring now to FIG. 2, there is depicted a non-volatile memory arrangement 22 (memory map) of a non-volatile portion of the memory 20. The non-volatile memory arrangement 22 may be flash memory or the like, and is preferably field programmable. The non-volatile memory includes a non-changeable area 24, a changeable area 26, and a non-changeable area 28. The non-changeable area 24 may be termed the boot code area since the boot code 34 for the computer controlled device 12 resides therein. The boot code area may start from a lowest memory address (generically 0x0000000 or 00000000 16) as depicted, or may start from a high memory address, depending on the computer reset vector address. The boot code 34 typically only contains the most fundamental features for booting up the computer controlled device 12 and achieve minimum size. The boot code 34 is also preferably provided in an uncompressed state.

Additionally, the boot code 34 is operable to boot up the operation of the application software operation, and can replace the existing application code with a newer version of application code when instructed to do so. The present boot code 34, however, does not include the features of authenticating and collecting the new application code from the DBS satellite (update channel 14). Upgrade of the boot code 34 may be accomplished in the factory or laboratory environment.

The changeable area 26 may be termed the application code area (ACA) since it contains the application code 32. The application code area 26 starts at the end of the boot code area 24 and can grow until it reaches a spare area 30. After the spare area 30, the memory address is at the beginning of the backing code area 28. Since the backing code 36 cannot be corrupted, the present invention preferably checks the-size of the current-application code to find out if the new application code and/or the current application code will come into the memory address of the backing code area. The checking method will be addressed below. The application code includes old application code and new application code.

The non-changeable area 28 may be termed a backing code area (BaCA) since it contains the backing code 36. The backing code 36 is preferably compressed or processed through image packing to reduce the size. The backing code 36 should reside at the other side of the non-volatile memory 22 away from the computer reset vector. In FIG. 1, the last byte of the backing code 36 should be at the highest address of the memory (i.e. 0xfffffff. The backing code 36 at the minimum should contain the feature of acquiring a new application code download (upgrade) in case of the current working code being corrupted. With proper memory resource and code compression, the backing code 36 can have the full features of the application code 32.

The backing code 36 is thus operable to-receive and authenticate a new application code download. As well, the feature set of the backing code 36 may be changed as required or desired. With a reasonable size of memory in the nonvolatile memory 22, properly selected feature sets for implementation, and a good image packing or compression algorithm to compress the backing code 36, a highly reliable and low cost upgrade operation of the computer controlled device 12 is achieved.

The backing code 36 is utilized by the boot code 34 should the application code become corrupted. This is diagrammatically depicted in FIG. 3 and reference is now made thereto. In FIG. 3, a manner in which the current, corrupted application code within a computer-controlled device is replaced is shown. Such a corruption may occur during a power failure or a power fail condition regarding the device 12. The backing code 36 is uncompressed by a feature of the boot code 34 and stored in volatile memory 38. The boot code 34 causes the now decompressed, backing code to become replacement application code 32 for the non-volatile memory 22. The boot code 34 installs the replacement application code in the changeable area 26. This replacement application code becomes the current application code which may then be upgraded.

The current release (i.e. version) of the application code may become the backing code upon compression of the current application code. Compression preferably is around a 50% ratio. The size of the backing code would then be only half of the application code. Since the backing code 36 is in the non-changeable area 28, the backing code is factory installed.

When the application code starts to have new features added in (from the upgrades) and its size thus starts to grow, the backing-code should start to reduce non-fundamental features. This gives room for the application code to grow. This is especially true if the spare area 30 between the application code 32 and the backing code 36 is already used up.

When using a non-power-fail-destructive download method to upgrade the backing code as in the method described below, the boot code must check if the new backing code will come into the application code area. A method for detecting the application code 32 and the backing code 36 start boundaries (addresses) and code block size in the non-volatile memory 22 could be as follows:

1. Each code block starts with a different data pattern. The data pattern has enough number of bytes such that no code block content will have the same pattern bytes;

2. After the code block boundary pattern, there should be the code block length and other code block related information;

3. When the boot code finds a newer application code block in the download buffer by searching the application code boundary pattern, then the boot code will is know (calculate) the new code size. The boot code will search for boundary data pattern of the backing code from the non-volatile memory area and make sure the new code size will not overlap with the backing code area comparing the application code size, the backing code start addresses, and overall non-volatile memory size; and

4. When the boot code finds a backing code in the download buffer, the boot code will be the same to make sure no overlapping between the application code and the backing code.

Referring now to FIG. 4, there is depicted a program flow, generally designated 50, showing how the backing code 36 starts to work. Initially, the computer controlled device is powered up, block 52. After power-up, the boot code will check the consistency of the application code in the non-volatile memory, block 54 (i.e. is the application code corrupted). If the-check fails (i.e. the application code is corrupted), the boot code will search for the data pattern of the backing code boundary, block 56. Once the boot code finds the data pattern and knows the backing code, block 58, the backing code can be properly decompressed, block 60. Proper decompression is by examining the information after the boundary data pattern. The boot code will then decompress the backing code into a dedicated volatile memory area called a download buffer. After this, the boot code will place the decompressed backing code into the application code area 26 in the non-volatile memory 22 and starts to execute the backing code that is now the application code.

If the backing code has the full feature set of the application code, the consumer will still have the full service from the product, such as in a DBS receiver. Otherwise, the consumer may need to wait until another application code upgrade has been successfully accomplished or may have partial service depending on the feature set.

The present apparatus and an associated method are applicable in performing computer code updates within any computer controlled device under download power fail destructive conditions. The device may be a DBS receiver, high definition television system, and the like, undergoing a new application code update via a DBS broadcast satellite system.

A method and apparatus in accordance with an aspect of the principles of the present invention are next presented, and are applicable in performing computer code updates within any computer controlled device having an integrated circuit card interface (commonly known as a smart card interface) as an update channel 14 or mechanism. Such computer controlled devices are in broad use in consumer electronics components such as, without being exhaustive, direct broadcast satellite television systems, set top boxes for cable and video-on-demand systems, high definition television systems, and the like.

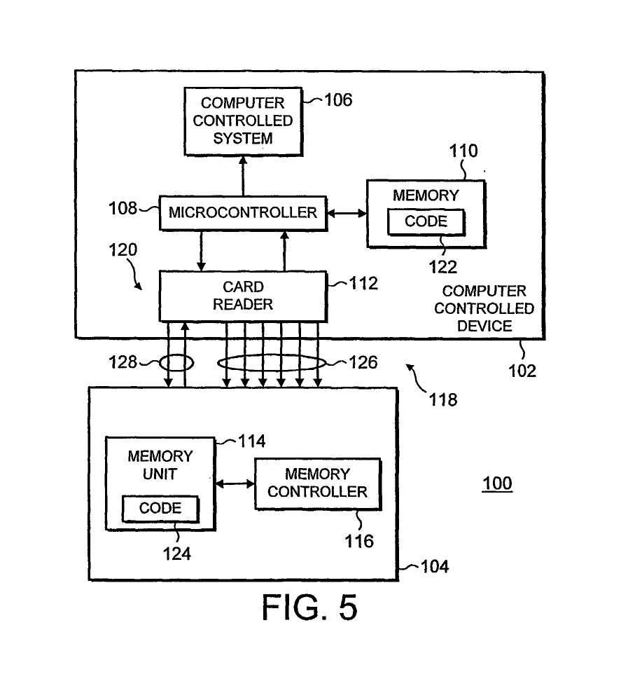

Referring now to FIG. 5, there is depicted a software updating system, generally designated 100, comprising a computer controlled device 102 having a smart/memory card interface 120 and a smart or memory card 104. The computer controlled device 102, like the computer controlled device 12 of FIG. 1, may be any type of computer controlled device that is operable to accept updates to its software, firmware and/or the like via an update mechanism or channel. The computer controlled device 102 comprises a microcontroller 108 (processing unit and/or the like), a computer controlled system 106 (e.g. the video processing functions of a television), and a memory 110. The computer code 122 to be updated and stored is in the memory 110. The computer controlled device 102 further contains a card reader 112 (or the like) for a smart card and/or a memory card and a connector 118 that form parts of the smart card interface 120 to the card 104. The smart card interface 120 can read either conventional smart cards which comply with the ISO standard 7816 smart card format or an NRSS type smart card, i.e. a 7816 compliant card having two high speed data ports. In the current embodiment of the invention, the NRSS smart card 104 depicted in FIG. 5, contains a memory unit 114 and a memory controller 116 which together form the card 104. The card reader 112 also reads conventional memory cards. It should be appreciated that-while a smart cart 104 is specifically shown, the present invention encompasses all types of smart and memory cards.

The connector 118 comprises eight conductor paths for activating and accessing the card 104. These paths include six paths 126 that comply with ISO standard 7816-2, namely: supply voltage, reset signal, clock signal, ground, programming voltage, and data input/output. In addition, the card 104 includes two paths 128 for a high-speed data input and a high-speed data output. Other embodiments of the invention may supply the software through the conventional 7816 I/O port, or through a completely different pin and port arrangement. A detailed description of a smart card interface for accessing a smart card having a conventional ISO standard 77816-2 connector with high speed data input and output capabilities is described in U.S. Pat. No. 5,852,290, issued Dec. 22, 1988 (filed Aug. 4, 1995), entitled “Smart-Card Based Access Control System With Improved Security”, and specifically incorporated herein by reference in its entirety.

After the card 104 is inserted into the smart card interface 120 the interface 120 determines whether the card 104 is a smart card (conventional or otherwise) or a memory card 104 containing the computer code update 124. After recognizing that a memory card 104 has been inserted, the microcontroller 108 activates an NRSS interface (as opposed to a conventional ISO standard 7816 or other interface for a smart or other type card) to utilize the high speed data ports and extracts the data (the executable computer code 124) from the memory (or other) card 104. This is accomplished at a rate of about 42 Mbits/second. The computer code 124 is channeled to the memory 110 and used to update the contents of the memory 110. In this manner, 3.5 Mbits code size can be updated in the computer controlled device 102 in less than two minutes. The term “update” is meant to include downloading “patch” or similar software that supplements existing software stored in the memory 110 as well as downloading entirely new software to the memory 110.

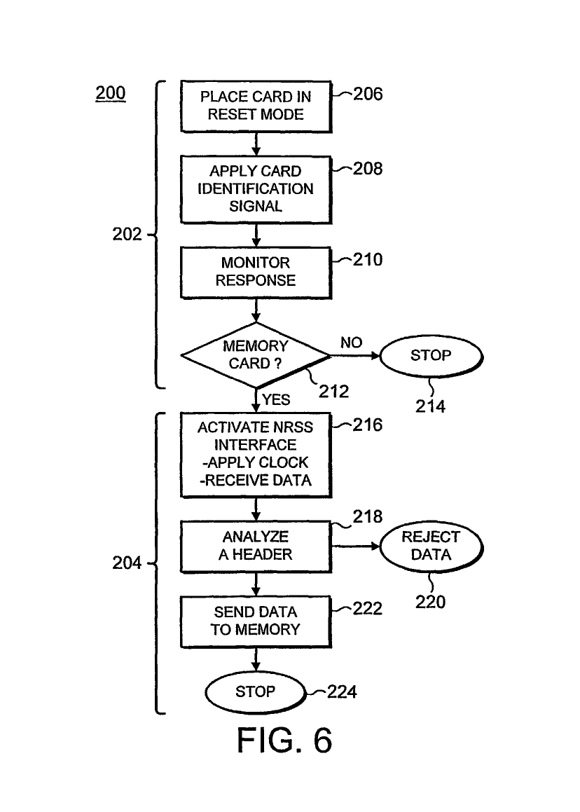

FIG. 6 depicts a flow diagram of a process, generally designated 200, used to update the computer code of a computer controlled device, such as those described herein. The computer code update process 200 is preferably performed in two stages. The first stage, designated 202, identifies a memory card as opposed to other types of smart cards for the computer controlled device. The second stage, generally designated 204, loads the data from the memory card into the memory of the microcontroller or like device of the computer controlled device. It should be appreciated that the process 200 is a particular implementation of the general process described above.

In the memory card identification stage 202, the microcontroller, at step 206, places the inserted card in ISO/7816 reset state, i.e. the interface toggles the reset signal path. In the reset state, a conventional smart card is in sleep mode, and will not respond to an external signal. As such, any signal applied to any of the pins of the smart card would be ignored by a conventional 7816 smart card. In contrast, a memory card, although in sleep mode, monitors the clock input path, e.g. a SC_CLK input terminal.

At step 208, the microcontroller applies a pulse signal to the smart card's SC_CLK terminal. The pulse signal, for example, transitions to high from low and back to high again. In response, the data input/output path of a memory card produces-an-opposite-state signal.

At step 210, the microcontroller monitors the data input/output path of the interface connection for a responsive signal. As such, the microcontroller will consider, at step 212, the inserted card as a memory card if the data input/output signal transitions from low to high and then to low, i.e. the data input/output signal is opposite the applied clock signal.

Otherwise, the routine 200 proceeds to step Z14 and stops. After the first (card identification) stage 202, is complete, the system starts to request data from the card. This occurs in the second (data loading) stage 204.

In the-data requesting-stage 204, the controller, at step 216, utilizes the NRSS interface, i.e., using NRSS_CLK and NRSS_DATA control input, to extract data, i.e., the new updated executable code, from the memory card at about 42 MB/second rate. The data stream header is analyzed at step 218.

According to the data stream header, the microcontroller will make a decision to accept the code data or reject it, as well as obtain operation termination conditions, i.e., obtain an end-of-file identifier. If the data is rejected, the routine 200 proceeds to step 220. If the data is accepted, at step 222, the data is sent to the memory within the computer controlled device for storage. The routine 200 stops, at step 224, when a termination condition is met, i.e., an error occurs, a data file end-of-file code is reached, or a power interruption.

It should be appreciated that the system 10 of FIG. 1 may utilize the card interface, card, and protocols as explained herein for the updating of the computer controlled device 12 thereof. In this regard, the card may be an access card similarly used in current DBS receivers. The access card may have the attributes of the card 104 of FIG. 5.

As well, it should be appreciated that the system 100 preferably utilizes the backup aspects of the present invention as explained herein. In particular, the system 100 is encompassed within the representation of the computer controlled device in FIG. 1. Thus, in one instance, the memory 110 of the computer controlled device 102 would be physically or virtually partitioned or divided as presented above and have the same or similar attributes. As well, the system 100 would include the other functionalities of the computer controlled device 102.

The present technique as exemplified above can be widely used on any type of firmware updateable imbedded systems such as set top boxes, consumer electronics equipment, and the like. It is very convenient for the service person to update the product software in the field, as well for the customer to update the product software themselves.

While this invention has been described as having a preferred design and/or configuration, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A computer controlled device comprising:
a processing unit; and
memory in communication with said processing unit, said memory partitioned into a first area containing boot code, a second area containing application code, and a third area containing backing code;
the boot code having a plurality of instructions which, when executed by said processing unit, causes said processing unit to:
(i) determine if said application code is corrupt; and
(ii) replace said application code with said backing code if said application code is corrupt.

2. The computer controlled device of claim 1, wherein said memory comprises non-volatile memory, and said first area is non-changeable, said second area is changeable, and said third area is non-changeable.

3. The computer controlled device of claim 2, wherein said non-volatile memory comprises flash memory.

4. The computer controlled device of claim 1, further comprising:
means for receiving upgrade application code to replace application code retained in said second area.

5. The computer controlled device of claim 4, wherein said means for receiving upgrade application code is operable to accept upgrade application code from any one of a plurality of upgrade channels.

6. The computer controlled device of claim 1, wherein said backing code is compressed.

7. The computer controlled device of claim 6, wherein said boot code is operable to uncompress said backing code.

8. A method for restoring corrupt application code in a computer controlled device comprising the steps of:
partitioning a memory of the computer controlled device into a boot code area containing boot code, an application code area containing application code, and a backing code area containing backing code;
determining if the application code is corrupt; and
replacing the application code with the backing code if the application code is corrupt.

9. The method of claim 8, wherein the step of determining if the application code is corrupt occurs after power-up of the computer controlled device.

10. The method of claim 8, wherein the backing code is compressed.

11. The method of claim 10, wherein the step of replacing the application code with the backing code if the application code is corrupt includes the step of:
uncompressing the backing code.

12. The method of claim 11, wherein the step of replacing the application code with the backing code if the-application code is corrupt further includes the steps of:
placing the uncompressed backing code into a volatile memory; and
moving the uncompressed backing code into the application area of the memory.

13. The method of claim 8, wherein the step of determining if the application code is corrupt includes the step of:
determining if a power fail has occurred during an upgrade of the application code; and
indicating that the application code is corrupt if a power fail has occurred during the upgrade.

14. A computer controlled device comprising:
a processing unit;
a memory in communication with said processing unit, said memory partitioned into a first area containing boot code, a second area containing application code, and a third area containing backing code;
a card reader in communication with said processing unit;
a card reader interface in communication with said card reader; and
means for authenticating then receiving upgrade application code from a memory card.

15. The computer controlled device of claim 14, wherein said memory comprises non-volatile memory.

16. The computer controlled device of claim 15, wherein said memory comprises flash memory.

17. The computer controlled device of claim 14, wherein said memory card is a smart card.

18. A method of upgrading application code in a computer controlled device, the application code contained in a non-volatile memory, the method comprising the steps of:
providing upgrade application code in a memory card;
inserting the memory card into the computer controlled device;
read a memory card identification signal;
activate a memory card interface in response to the card identification signal; and
replacing the application code with the upgrade application code from the memory card.
